(19) United States
(12) Patent Application Publication
(10) Pub. No.: US 2007/0253405 A1
(43) Pub. Date: Nov. 1, 2007

(54) Method and apparatus for initiating a user selected service when establishing a packet data connection

(75) Inventors: Lawrence A. Willis, McHenry, IL (US); Michael F. Coulas, Buffalo Grove, IL (US)

Correspondence Address: MOTOROLA INC, 600 NORTH US HIGHWAY 45, ROOM AS437, LIBERTYVILLE, IL, 60048-5343, US

(73) Assignee: MOTOROLA, INC.

(21) Appl. No.: 11/412,502

(22) Filed: Apr. 27, 2006

(51) Int. Cl. H04L 12/66

(52) U.S. Cl. 370/352

(57) ABSTRACT

The present invention provides a method and apparatus for initiating a user selected service, which makes use of a packet data connection, in conjunction with establishing the packet data connection. The method includes receiving a request to initiate a user selected service, which uses a packet data connection, prior to the establishment of the packet data connection. An activation request is then sent for establishing a packet data connection, the activation request includes user selected service parameters for use in defining a user selected service. The user selected service is then initiated as part of establishing the packet data connection. The apparatus includes a processor coupled to a user input for receiving a request to initiate a user selected service and a transceiver for communicating with a network. The processor includes a connection module adapted for establishing a packet data connection via the transceiver. The connection module has a user service initiation module for initiating the user selected service as part of establishing a packet data connection.

### FIELD OF THE INVENTION

The present invention relates generally to initiating a user selected service in association with a communication network, and more particularly, to initiating the user selected service as part of establishing a communication connection.

### BACKGROUND OF THE INVENTION

General Packet Radio Service (GPRS) and Enhanced Data for Global Evolution (EDGE) for the Global System for Mobile Communication (GSM) have introduced the capability of the interchange of user data in mobile communication networks. When these standards for data services were originally envisioned and developed, they were intended to support data transmissions that were primarily intermittent (i.e. non-periodic) and packet based, which tended to include frequent small transfers of data (i.e. typically less than 500 octets, each), or infrequent large transfers of data (i.e. could be more than several hundred kilobytes). At least some of the interactions that these data services were envisioned to support included Internet browsing, electronic mail, etc. In some instances, the data services support file downloads, where the files might include applications that are to be executed and/or support the functioning of the device, or might contain content that is to be rendered by the device and conveyed to the user, such as video and audio content.

When the corresponding data standards were initially developed, the developers did not anticipate the desire to support the implementation of more delay sensitive applications using a data channel connection provided in accordance with the data service. The desire for many of these services are driven by an erosion of the barrier between the packet data networks, which supports the Internet and the wireless cellular networks, where access to data present in one of the two domains can be more readily accessed in the other one of the two domains, and the desire for services associated with the Internet to be accessed via a wireless communication device, such as a cell phone. An examples of a delay sensitive data application includes the streaming of content.

In other instances, application developers and/or network providers have elected to implement new forms of broadcast communication services, such as at least some forms of push-to-talk communication, as well as video or voice conferencing, via the data services. However in so doing, it has become necessary to address latency times associated with establishment of a data connection and the conveyance of the packets of data, via the data services, balanced with respect to the desired latency times associated with supporting the more time sensitive services, that the data services when developed were not intended to support. For example, the establishment of a GPRS/EDGE Packet Data Protocol (PDP) context or data connection can be delay prone. While typically, the delays are shorter than ten seconds, in some instances the activation of a PDP context can be delayed as long as 120 seconds. Regardless, in instances such as push-to-talk applications, even a delay on the order of ten seconds can be viewed as unreasonably long, where a user is typically expecting a more instantaneous access for purposes of an on-demand walkie-talkie type communication.

In some instances, it may be possible to use an “always-on” PDP context, which minimizes and/or eliminates any recurring delay associated with establishing a communication channel, and correspondingly reduces the delay associated with supporting the particular user plane (i.e. packet data or Internet Protocol (IP) based) application or service. However, an “always-on” PDP context can sometimes unnecessarily consume potentially limited network resources, such as the available IP addresses, where a particular dynamic IP address associated with an always on established context is potentially underutilized.

Even after a PDP context is established, a user selected service, such as a push-to-talk packet data voice communication service, generally requires a push-to-talk client application operating on the user device to register with a session initiation protocol registrar server, and for the push-to-talk client application to then use session initiation protocol directives to subscribe to a push-to-talk presence server. Subscribing to the push-to-talk presence server enables the device to be registered with the presence server and allows for the device to be subscribed to receive presence notifications associated with other push-to-talk users.

The present inventors have recognized that it would be beneficial to develop an apparatus and/or approach, which reduces the delay associated with initiating a user selected service, which makes use of a packet data network, in conjunction with establishing the packet data connection. Still further, it would be beneficial if the apparatus and/or approach can reduce the delay associated with initiating the user selected service in instances where an “always-on” PDP context is not being used.

### SUMMARY OF THE INVENTION

The present invention provides a method of initiating a user selected service, which makes use of a packet data connection, in conjunction with establishing the packet data connection. The method includes receiving a request to initiate a user selected service, which uses a packet data connection, prior to the establishment of the packet data connection. An activation request is then sent for establishing a packet data connection, the activation request includes user selected service parameters for use in defining a user selected service. The user selected service is then initiated as part of establishing the packet data connection.

In at least one embodiment, initiating the user selected service includes at least one of registering with a user selected service registrar and subscribing to an application server.

In at least a further embodiment, upon receiving the activation request, a proxy is established to at least one of register with the user selected service registrar and subscribe to the application server.

The present invention further provides an activation context request message for establishing a packet data connection. The activation context request message includes a network access point name, a transaction identifier, and one or more protocol configuration options including at least one of a user selected service register identifier, an address for a user selected service server, and an address of a subscriber unit.

The present invention still further provides for a wireless communication device. The wireless communication devices includes a user input adapted for receiving a request to initiate a user selected service. The wireless communication device further includes a transceiver, which is adapted for communicating with a network. The wireless communication device still further includes a processor coupled to the user input and the transceiver. The processor includes a connection module adapted for establishing a packet data connection via the transceiver. The connection module has a user service initiation module for initiating the user selected service as part of establishing a packet data connection.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a block diagram of at least a portion of an exemplary packet data network;

FIG. 2 is a message sequence diagram for establishing a data connection and initiating a user selected service, in accordance with at least some prior systems;

FIG. 3 is a message sequence diagram for establishing a data connection and initiating a user selected service, in accordance with at least one embodiment of the present invention;

FIG. 4 is a block diagram of an activation context request message, in accordance with at least one embodiment of the present invention;

FIG. 5 is an exemplary format for encoding protocol configuration options for use with the activation context request message illustrated in FIG. 4;

FIG. 6 is a block diagram of a wireless communication device, in accordance with at least one embodiment of the present invention; and

FIG. 7 is a flow diagram of a method for initiating a user selected service, in conjunction with establishing a packet data connection.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

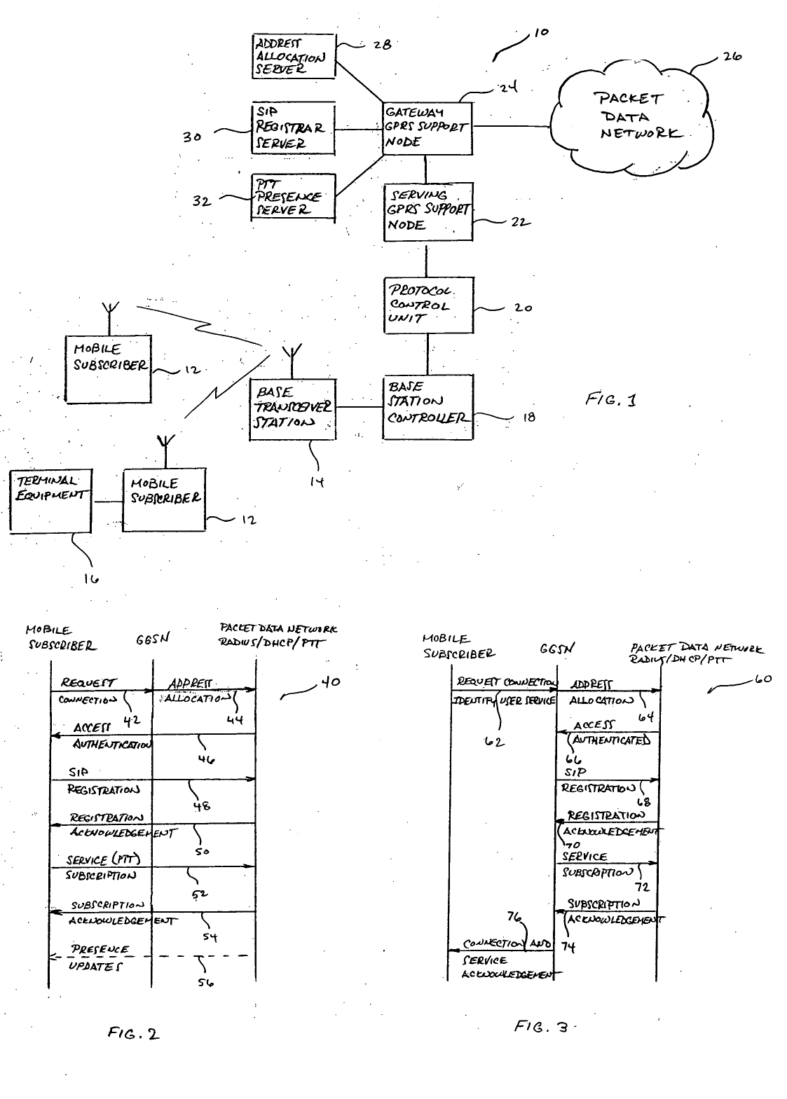

FIG. 1 illustrates a block diagram of an exemplary packet data network 10 including portions of a cellular communication network which support packet data transfers, for example elements, which might support General Packet Radio Service (GPRS) and Enhanced Data for Global Evolution (EDGE) standards within a communication system supporting a Global System for Mobile Communication (GSM) standard. GPRS and its superset EDGE, which are intended to support more efficient use of the radio and network resources of a cellular based communication system in the context of packet based data communications, in some instances are used to facilitate communication with the Internet and other packet based data communication networks and systems, that extend beyond the cellular network. However while GPRS, EDGE and GSM represent examples of communication standards with which the present invention is intended to operate, one skilled in the art will readily appreciate that the teachings of the present application are not limited for use with systems that support these standards, but similarly could be applied in instances where the initiation of a user selected service could benefit from being initiated in conjunction with establishing the data connection. Consequently, despite the present application being largely described in a context consistent with a GPRS/EDGE and GSM supported environment, the benefits associated with the present invention may likely extend to still other communication environments.

In the illustrated embodiment, the exemplary packet data network 10 includes one or more mobile subscribers 12, which typically communicate wirelessly with a base transceiver station 14, which is generally associated with a particular geographic region referred to as a cell. In addition to supporting communication between the base transceiver station 14 and the one or more mobile subscribers 12, the mobile subscribers will sometimes further support the wireless communication of information between terminal equipment 16, which might be coupled to a mobile subscriber 12, and the cellular network, via the base transceiver station 14. A couple of examples of terminal equipment 16 can include personal computers, facsimile machines, and/or headsets. In addition to terminal equipment 16, which might be communicatively coupled to the mobile subscriber 12 via a wired connection, terminal equipment 16 may also communicatively couple to the mobile subscriber 12 via a further wireless communication connection, such as in the case of a wireless headset. An example of a further wireless connection may include a communication connection in accordance with the Bluetooth® standard, or a standard that supports a Wireless Local Area Network (WLAN), such as 802.11.

In the illustrated embodiment, on the network side, the base transceiver station 14 is coupled to a base station controller 18. The base station controller may also be coupled to other base transceiver stations, which support the same or other geographical regions. The base station control unit is coupled to a protocol control unit 20, which in turn is coupled to a serving GPRS support node 22. Still further, the serving GPRS support node 22 is coupled to a gateway GPRS support node 24. The gateway GPRS support node 24 often provides a point of access between the cellular network infrastructure and the external packet data network 26, such as the Internet. The gateway GPRS support node 24 can additionally be coupled to one or more servers either directly or indirectly, such as via the packet data network 26, which can provide control, support and/or content for one or more services, such as support for services over the packet data network 26.

An example of a service that might be supported over the packet data network 26 includes the streaming of data, such as audio or video data, which might be used to support the rendering of content being broadcast or might be supplied on demand. The streaming audio or video data could alternatively or additionally support video conferencing. Further examples of services might include voice over IP type applications, and/or push to talk type applications. In some instances, one or more servers may support the functioning of the packet data communication, itself. For example, one or more servers may support a domain naming service, which translates between an address name and its numeric equivalent. Still further, some servers may support the dynamic allocation of a numeric address. In some instances, a particular server may be coupled to the gateway GPRS support node 24, but may still be part of the cellular infrastructure. In other instances, a particular server may be part of the external packet data network 26, and may be coupled to the gateway GPRS support node 24 via the gateway GPRS support node's connection to the external packet data network 26.

In the illustrated embodiment, three exemplary servers are shown. The three servers include an address allocation server 28, a Session Initiation Protocol (SIP) registrar server 30, and a Push To Talk (PTT) presence server 32. While each of the three servers are illustrated separate from the packet data network 26, one or more of the servers could alternatively be accessed via and/or may be part of the packet data network 26. Furthermore, while each of the servers are illustrated as separate elements, the services and/or content associated with a plurality of the illustrated servers could be combined to form part of a single server and/or some of the servers could be co-located. For example, it is envisioned that the SIP registrar server 30 and the PTT presence server 32 could be co-located.

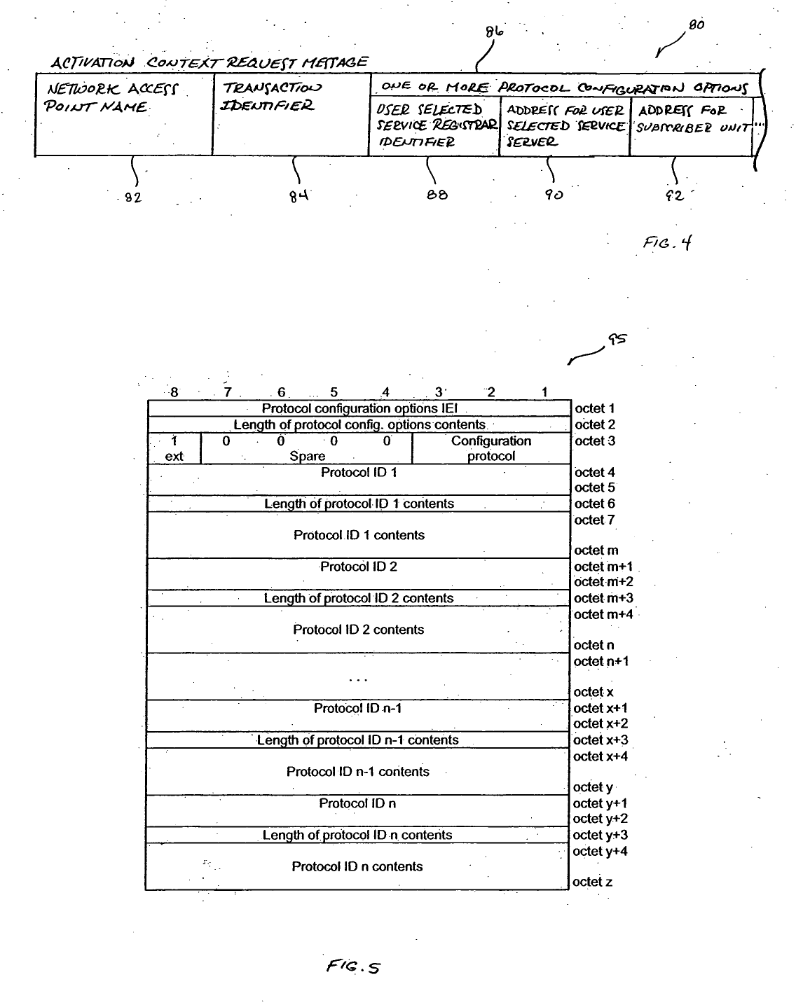

Traditionally, the mobile subscriber, in conjunction with the network infrastructure, has participated in the sequential establishment of a data communication connection and the initiation of a user selected service. In other words, the mobile subscriber would process and execute commands to establish a communication connection, and then after the mobile subscriber receives an acknowledgement of the establishment of the communication connection, the mobile subscriber would then process and execute commands to initiate a particular user selected service. An example of a message sequence diagram 40 for establishing a data connection and initiating a user selected service, in accordance with at least some prior systems, is illustrated in FIG. 2. For the sake of simplicity some of the network elements have been omitted. In many of these instances the omitted network elements, while part of the communication path, largely function to properly route the communication packets between the source and destination for a particular communication message, and/or their role remains largely unchanged between the typical prior messaging sequences, and the messaging sequence diagram 60 as modified in connection with the teachings of at least one embodiment of the present invention, as illustrated in FIG. 3. In the case of the packet data network and/or the one or more servers, the visual representations of the elements as a source or destination of messages in the message sequence are commonly identified, even though the elements may represent separate and/or geographically distinct elements. Similar to some of the network elements noted above which have not been illustrated, the roles of the packet data network and the one or more servers, relative to the illustrated communication sequences, are largely unchanged.

Generally, the illustrated message sequence, shows the conveyance of an abbreviated and/or partially consolidated sequence of messages for establishing a packet data connection, and initiating a user selected service, such as a push-to-talk (PTT) communication service, which involves registration with a SIP registrar server, and registration and subscription with a PTT presence server for initiating the user selected service and subscribing to presence notifications associated with other PTT users. Initially, a message for requesting 42 the establishment of a communication connection is sent from the mobile subscriber 12, which is sometimes referred to as user equipment. The request is forwarded to the gateway GPRS support node (GGSN) 24. As part of requesting a connection, the mobile station needs to be authenticated and an address needs to be allocated 44 to the mobile subscriber 12 to support the addressing of subsequent communications, assuming an address is not already associated with the mobile subscriber 12. This can sometimes involve a radius server which can serve to authenticate the mobile subscriber 12 and establish an accounting associated with the use of the communication connection being established and the address being allocated. Furthermore a Dynamic Host Configuration Protocol (DHCP) server can be accessed in the allocation of an address from a pool of available addresses. While not illustrated, sometimes the serving GPRS support node (SGSN) 22 can be involved in receiving the request 42 for establishing a communication connection from the mobile subscriber, and creating the form of the request that is then received by the GGSN 24.

An indication 46 of access authentication is then conveyed from the network to the mobile subscriber 12, which upon receipt of the indication, prompts the initiation of a registration 48 with the SIP registrar server 30. SIP provides a means by which applications can establish a communication session via a communication connection that has been established. For example, SIP can be used to negotiate the features and capabilities of the session at the time the session is established. Upon receipt of an acknowledgement 50 of registration with the SIP registrar server 30, the Session Initiation Protocol (SIP) can be used to register with the PTT presence server and subscribe to the PTT presence notification of other users 52. In turn, a corresponding acknowledgement is received 54, as well as subsequent occasional presence updates 56.

Throughout the message sequence, the mobile subscriber 12 plays a very active role, with many of the steps in the process originating or terminating with mobile subscriber 12. Communications which involve the mobile subscriber, generally, include at least one leg of the journey which involves a wireless communication connection between the mobile subscriber 12 and a base transceiver station 14. Frequently, it the wireless communication connection between the mobile subscriber 12 and the base transceiver station 14, which introduces a significant source of delay, relative to the message sequence, or represents a limited resource, which must be shared between multiple different potential users.

Alternatively, the present invention proposes to reduce the delay associated with initiating a user selected service, in conjunction with establishing a communication connection, by incorporating at least some of the information, which is used to initiate the user selected service, and which would originate from the mobile subscriber, as part of the command(s) used to establish a communication connection. In turn the additional information can be used to initiate the user selected service as part of establishing the packet data connection, while reducing the number of interactions between the mobile subscriber and the rest of the cellular and the packet data networks.

An alternative message sequence 60, which is consistent with at least some aspects of the present invention, is illustrated in FIG. 3. In the illustrated embodiment, the GGSN 24 is adapted to act as a proxy for the mobile subscriber 12 in connection with initiating the user selected service. In turn, at least some of the communications, which might otherwise have originated with the mobile subscriber 12 can originate with the GGSN 24, and in turn shorten the communication chain for at least some of the communications. In order to support the GGSN 24 in its role as a proxy for the mobile subscriber 12, the initial request from the mobile subscriber 12 can contain additional information, which may be conveyed as protocol configuration options, when the initial request is transmitted. In turn, the GGSN 24, then interfaces with the various servers, while reducing the direct involvement of the mobile subscriber 12. In turn communications between some of the other network elements, such as the SGSN 22, the protocol control unit 20, the base station controller 18, and the base transceiver station 14, are similarly reduced.

While the proxy in the present application is illustrated and described as being established in the GGSN 24, one skilled in the art will appreciate that the proxy might alternatively be established in some of the other network elements, such as elements along the traditional chain of communication and/or a new entity whose purpose might include providing proxy services, and still enjoy at least some of the benefits of the teachings of the present invention, and therefore such a modification to the particular embodiments described herein would not be seen as a departure from the broadest teachings of the present invention.

The message sequence 60, illustrated in FIG. 3, includes a request 62 for a communication connection, which in addition to requesting a connection identifies a user selected service, as well as one or more parameters, which might be necessary for supporting the establishment, creation and/or support of a service. The authentication of the mobile station and the allocation 64 of an address is largely handled similar to the authentication and address allocation 44 noted above in connection with FIG. 2. However, when the network elements respond with an access authentication 66, instead of the message being immediately forwarded to the mobile subscriber 12, the proxy operating within the GGSN 24 on behalf of the mobile subscriber 12 formulates and conveys the communications, which facilitate the initiation of the user selected service. In the exemplary embodiment, the proxy handles the formulation and conveyance of the SIP registration message 68, and then, receives the registration acknowledgment 70, formulates and conveys the service subscription message 72 and receives the subscription acknowledgment 74. An aggregate acknowledgment of the established connection and initiated service 76 is then conveyed to the mobile station.

The message sequence 60, illustrated in FIG. 3, is intended to represent one example of a potential message sequence in accordance with the present invention. One skilled in the art could readily envision still further messages and/or a subset of the illustrated messages, which might be accommodated by the established proxy, and still provide a useful benefit, in accordance with the present invention.

In order to support the initiation of the proxy, which in turn supports the initiation of a user selected service as part of or in conjunction with establishing a communication connection, it may be helpful and/or necessary for the mobile station to convey additional information as part of the request to establish a communication connection 62. FIG. 4 illustrates an exemplary activation context message 80, in accordance with at least one aspect of the present invention. The activation context message 80 includes an identification of a network access point 82, which identifies the entity through which access to the network is desired and/or is to be sought. The activation context message 80 further includes a transaction identifier 84, which enables a particular communication connection (i.e. data flow) to be uniquely identified, where it is possible for multiple data flows to share the same packet data protocol and network access point.

In the illustrated embodiment, the activation context request message additionally includes one or more protocol configuration options 86. As illustrated in the exemplary embodiment, the one or more protocol configuration options 86 can include a user selected service registrar identifier 88, an address for the user selected service server 90, and an address for the subscriber unit 92. In connection with the illustrated embodiment, the subscriber unit 92 generally corresponds to the mobile subscriber 12 and/or the terminal equipment 16, which might be coupled to the mobile subscriber 12.

The additional information conveyed as part of the protocol configuration options is intended to convey information, which is useful in initiating the user selected service, which in turn can be used by a proxy that is established within the network, which is operating on behalf of the mobile subscriber in connection with the corresponding communication connection request. An Example of still further potential information that could be conveyed as a protocol configuration option includes a protocol version, in addition to various other protocol identifiers which are supported as protocol configuration options in association with alternative transactions and/or configuration protocols, such as link control protocol, password authentication protocol, challenge handshake authentication protocol, or IP control protocol.

A still further example of additional information that could be conveyed as a protocol configuration option, which might be relevant in association with subscribing to an application server, includes an indication of the type and content of information the successful subscription is intended to supply to the mobile subscriber. In at least some instances, this is sometimes referred to as an event package. Examples of different types of event packages includes information concerning someone's presence, information about your pending voice mail messages (or some other type of message, such as SMS), and/or information about your registered identities. The above noted event packages may be separately identified as a presence event package, a message summary event package, or a registration event package. In absence of an express indication by way of a protocol configuration option, or other manner of conveying the information, it may be possible in some circumstances for the established proxy to have a defined default event package for purposes of supporting a subscription to an application server.

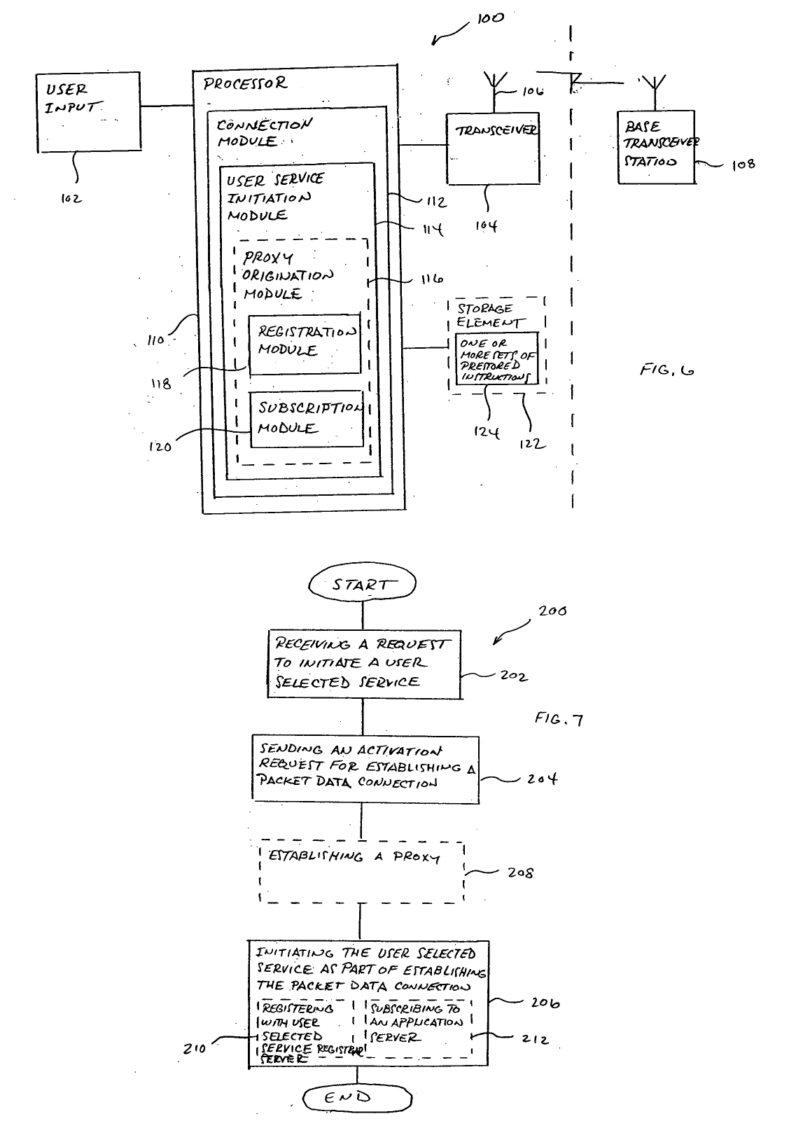

Protocol configuration options are often conveyed in the form of a table. An example of at least one such table 95 supported by existing specifications, is illustrated in FIG. 5. The table 95 includes a sequence of 8 bit blocks of information referred to as octets. The first octet is reserved for the protocol configuration options information element index. The second octet provides the length of the protocol configuration options contents. The third octet identifies the configuration protocol to which the options are intended to apply. In the particular example, the configuration protocol includes a sub-field, which can be used to identify the configuration protocol. For example, this can include a value in a three bit field, which might support one particular protocol, and an alternative value in the three bit field, which might support a still further protocol, such as the one described herein for initiating a user selected service as part of establishing a communication connection. In each instance, there may be a particular subset of authorized protocol identifiers, to be conveyed as a protocol configuration option. The subsequent groups of elements include three entries corresponding to each protocol configuration option included in the table. Each group of three entries includes a protocol identifier, an indication of the length of the particular protocol identifier contents, as well the protocol identifier contents.

The configuration options are intended to provide information from the mobile subscriber, which supports subsequent communications, which is handled by the proxy, but which is not alternatively generated by the network. In some instances, some of the information used in forming subsequent messages initiated by the proxy is generated in response to prior communications between the proxy and the corresponding network elements. In other instances, some of the information may be part of a template stored in the entity in which the proxy is being created. Generally, the templates will be generic to most mobile subscriber. However, in some circumstances, it may be possible to store information specific to the mobile subscriber or type of mobile subscriber in support of communications associated with services for the particular mobile subscriber. Otherwise, as noted above, information specific to a particular mobile, which is necessary for supporting the initiation of the user selected service as part of establishing the communication connection can be conveyed as part a protocol configuration option.

FIG. 6 illustrates a wireless communication device 100, in accordance with one embodiment of the present invention. In the present example, the wireless communication 100 represents at least one example of a mobile subscriber 12, described above. The wireless communication device 100 includes a user input 102, which is adapted for receiving a request to initiate a user selected service. In at least one instance, the user input could be an actuatable switch, such as an electromechanical push button. However, presumably, one skilled in the art will recognize that there are many ways that a user input could be provided. For example, the user input could include a selection of a particular element from a list of elements, such as a menu displayed on a screen, or could involve the selection of a corresponding icon. As a still further example, the user input could be associated with a detectable voice command, via a microphone which is integrated as part of the wireless communication device. The wireless communication device further includes a transceiver 104, coupled to an antenna 106, which is adapted for communicating with a network, such as via a base transceiver station 108.

The wireless communication device 100 still further includes a processor 110, which is coupled to the user input 102 and transceiver 104. The processor 110 includes a connection module 112, which is adapted for establishing a packet data connection. The connection module 112 has a user service initiation module 114, which is adapted for initiating the user selected service as part of establishing a communication connection, such as a packet data connection, in response to detecting a corresponding detected user input, which requests an initiation of a user selected service. As noted above, in at least some embodiments, the user selected service is initiated as part of establishing a communication connection by creating a proxy, which preferably resides within the network for handling at least some of the communication interactions on behalf of the wireless communication device 100, i.e. mobile subscriber. Such a proxy, in at least some embodiments, is created through a proxy origination module 116, which in at least some instances forms part of the user service initiation module 114. In some of these instances the proxy created may manage the registration with a user selected registrar server and the subscription to an application server, via a corresponding registration module 118 and subscription module 120.

In some embodiments, the processor could be implemented in the form of a microprocessor, which is adapted to execute one or more sets of prestored instructions 124, which may be used to form at least part of one or more processor modules. The one or more sets of prestored instructions may be stored in a storage unit 122, which is either integrated as part of the processor or is coupled to the processor 110. The storage unit 122 can include one or more forms of volatile and/or non-volatile memory, including conventional ROM 221, EPROM 223, RAM 225, or EEPROM 227. The storage unit may still further incorporate one or more forms of auxiliary storage, which is either fixed or removable, such as a harddrive or a floppydrive. One skilled in the art will still further appreciate, that still other further forms of memory could be used without departing from the teachings of the present invention. In the same or other instances, the processor may incorporate state machines and/or logic circuitry, which can be used to implement at least partially, some of modules and their corresponding functionality.

FIG. 7 illustrates a flow diagram 100 of a method for initiating a user selected service, in conjunction with establishing a packet data connection. The method includes receiving 202 a request to initiate a user selected service. Generally, the user selected service uses a communication connection, such as a packet data connection, and the request is received prior to the establishment of the corresponding communication connection. An activation request is then sent 204 for establishing a packet data connection, where the activation request generally includes user selected service parameters for use in defining the user selected service. The user selected service is then initiated 206 as part of establishing the communication connection.

In at least some embodiments, a proxy is established 208 in response to sending 204 the activation request. Furthermore, in at least some embodiments, initiating the user selected services as part of establishing the communication connection includes registering 210 with the user selected service registrar server and subscribing 212 to an application server.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of initiating a user selected service, which makes use of a packet data connection, in conjunction with establishing the packet data connection, said method comprising:
receiving a request to initiate a user selected service, which uses a packet data connection, prior to the establishment of the packet data connection;
sending an activation request for establishing a packet data connection, said activation request includes user selected service parameters for use in defining a user selected service; and
initiating the user selected service as part of establishing the packet data connection.

2. A method in accordance with claim 1 wherein the request to initiate a user selected service is encoded as one or more parameters associated with the activation request used to establish the packet data connection.

3. A method in accordance with claim 2 wherein at least some of the one or more parameters are included as protocol configuration options of the activation request.

4. A method in accordance with claim 3 wherein the protocol configuration options include session initiation protocol information.

5. A method in accordance with claim 4 wherein the session initiation protocol information includes at least one of a user selected service registrar identifier, an address of a subscriber unit, an address of the server for the user selected service, an event package identifier, and the protocol version.

6. A method in accordance with claim 1 wherein the user selected service includes packet data voice communication.

7. A method in accordance with claim 1 wherein initiating the user selected service includes at least one of registering with a user selected service registrar and subscribing to an application server.

8. A method in accordance with claim 7 wherein upon receiving the activation request, a proxy is established to at least one of register with the user selected service registrar and subscribe to the application server.

9. A method in accordance with claim 8 wherein a network gateway support node operates as the proxy.

10. An activation context request message for establishing a packet data connection comprising:
a network access point name;
a transaction identifier; and
one or more protocol configuration options, the protocol configuration options being selected from a list including a user selected service registrar identifier, an address for a user selected service server, an address of a subscriber unit, and an event package identifier.

11. A wireless communication device comprising:
a user input adapted for receiving a request to initiate a user selected service;
a transceiver adapted for communicating with a network; and
a processor coupled to the user input and the transceiver, the processor including
a connection module adapted for establishing a packet data connection via the transceiver and having a user service initiation module for initiating the user selected service as part of establishing a packet data connection.

12. A wireless communication device in accordance with claim 11 wherein the user service initiation module includes a proxy origination module for creating a proxy, which is used to start the selected user service.

13. A wireless communication device in accordance with claim 12 wherein the proxy origination module includes at least one of a registration module for establishing a registration with a user selected service registrar server and a subscription module for establishing a subscription to an application server.

14. A wireless communication device in accordance with claim 11 wherein the user selected service includes packet data voice communication.

15. A wireless communication device in accordance with claim 11 wherein said connection module includes one or more sets of prestored instructions.

16. A wireless communication device in accordance with claim 15 further comprising a storage element coupled to the processor adapted for storing the one or more sets of prestored instructions.

17. A wireless communication device in accordance with claim 11 wherein the wireless communication device is a cellular telephone.

18. A wireless communication device in accordance with claim 11 wherein the packet data connection is part of at least one of a general packet radio service (GPRS) and enhanced data for global evolution (EDGE) of a global system for mobile communication (GSM).
